(19) United States
(12) Patent Application Publication
(10) Pub. No.: US 2011/0218843 A1
(43) Pub. Date: Sep. 8, 2011

(54) NON INTRUSIVE SYSTEM AND METHOD FOR MONITORING BUSINESS PROCESSES

(75) Inventors: Sukriti Goel, Bangalore (IN); Jyoti M. Bhat, Bangalore (IN)

(73) Assignee: Infosys Technologies Limited, Bangalore (IN)

(21) Appl. No.: 12/719,176

(22) Filed: Mar. 8, 2010

(51) Int. Cl. G06Q 10/00

(52) U.S. Cl. 705/7.39; 705/348

(57) ABSTRACT

The invention allows at least one business process to execute in at least one application while the same is monitored the progress in non-intrusive manner. The various embodiments of the present invention provide a method and system to monitor the business transactions in process unaware systems non-intrusively. The activities occurring in a business process are set up using a business model. The events in the business process are identified based set of application data of a plurality of applications associated with the business process. The identified events are mapped to activities and the activities are mapped to process instances based on predefined mapping rules. Key performance indicators are set for each of the activities in the business process. At least one subsequent activity to be completed for the process instance is determined. An alert is created when KPI violation occurs with respect to the completed activity.

### FIELD OF THE INVENTION

The present invention relates, in general, to systems for monitoring business transactions and more particularly to systems and methods for monitoring business transactions non-intrusively.

### BACKGROUND OF THE INVENTION

In the globalized competitive market, companies need real time visibility into process execution to maintain control over their business operations and to ensure efficient decision making. Process visibility indicates a capability to measure and monitor process Key Performance Indicators (KPIs) and adherence of service level agreements (SLAs) and compliance requirements.

A business process is a group of business activities undertaken by an organization in pursuit of a common goal. Business processes of most organizations are implemented across many applications, legacy systems, Enterprise resource planning (ERP) systems and software products. The process flow is achieved by integration and data hand offs between applications, systems and programs. The process flow is not explicit in such scenarios. A single business process may be implemented across multiple systems. For example, in an order management process, systems from finance, accounting, delivery, and storehouse may be required. In such scenarios monitoring of end to end business processes is a challenge. Intrusive methods like code changes and introducing of probes are typically used for monitoring the business transactions.

The term business process management (BPM) refers to activities performed by business to manage the processes which include understanding and documenting, the processes and optimizing the same. The activities also include compliance management, automation, and execution and continuous monitoring the processes. It also includes the softer aspects such as change management and governance. BPM includes process modeling, data integration, workflow, and business activity monitoring.

Business Activity Monitoring tools are available in the market to monitor a business process. The goals of Business Activity Monitoring (BAM) are to provide real time information about the status and results of various operations, processes, and transactions. The main benefits of BAM are to enable an enterprise to make better informed business decisions, quickly address problem areas, and re-position organizations to take full advantage of emerging opportunities. However, these BAM tools require a process aware system (i.e. where the process is explicitly implemented in the system) to provide monitoring capabilities. But when business processes are implemented in systems which are application silos and workflow is manifested by integration of the application silos at the IT layer, the conventional BAM tools will not be of much assistance.

Many organizations have system implemented in languages which are difficult to understand and change. Also, at times due to the presence of obsolete technology in some business processes, it becomes tough to find competent people to tackle errors. In some cases the system is so complex organizations do not want to touch the system for the fear of introducing errors into a working system. In other cases processes are implemented across disparate systems and a process level monitoring is not available. In addition to that adding probes would mean performance degradation in the system, which may not be acceptable in most cases. In all such scenarios, organizations cannot monitor their business processes and gain process visibility without having to make any changes or intrude into the execution of the processes implemented in the existing systems.

In some applications, business users raise support tickets when a particular instance of the business process is lost due to IT system failure. The IT production support team then has to manually go through logs and isolate the instance to analyze and fix the problem. Hence there is a need to alert the IT support group when the business transaction fails due to system problems to proactively identify the problem and fix them. The process monitoring can be useful in compliance management of processes executing in multiple systems/applications non-intrusively.

Some of the tools which provide process monitoring capability use intrusive mechanisms to access process execution instances. Such intrusive mechanisms include code changes to create a transaction log (logging) or intrusion in the middleware layer or network layer to listen to the process execution. However, such mechanisms intrude the normal process execution flow and introduce a delay in completing the process instance.

Solutions that exist in the market involve intrusion either at the code level, by introducing a middleware or at the database layer to include logging or tracking mechanisms. Hence, there is a need to develop a non-intrusive method of monitoring business processes that can read process application data and provide timely monitoring capability at an individual business transaction level. There is also a need to provide alerts to the group when as and when a business transaction fails to fix the problem occurred.

### BRIEF SUMMARY OF THE INVENTION

The above mentioned shortcomings, disadvantages and problems are addressed herein and will be understood by reading and studying the following specification.

The various embodiments of the present invention provide a system and method to monitor the business transactions in process unaware systems non-intrusively and to provide alerts to users to enable the users to take alternate preventive/corrective action for the specific business process instance such as when business events like SLA violation occurs.

According to one embodiment of the present invention, a method to monitor business transactions in at least one business process non-intrusively is provided. The method includes the step of setting activities of at least one business process that needs to be monitored. Further, the method includes the step of identifying one or more events occurring in the business transactions of the at least one business process using a set of application data. The identified events are mapped to a set of activities in the business process based on a set of predefined mapping rules. The method also includes the step of setting key performance indicators for each of the set of activities in the business process. Further, at least one subsequent activity to be completed in the business process for each process instance is determined. Each completed activity is then compared with list of determined activities and mapped to a business process instance. An alert is generated when any of the set of activities fails to meet the key performance indicators.

According to another embodiment of the present invention, a non-intrusive monitoring system is provided to monitor at least one business process. According to the system, a process modeler generates a business process model representing a set of activities in the at least one business process. An event handler collects a set of application data stored by the set of applications. An event-process correlator correlates a set of events to one of the activities in a process instance. Further, the system includes a key performance indicator (KPI) modeler that captures the KPI values for the set of activities included in the generated business model. An alert engine generates an alert for the completed activities based on the captured KPI and SLA values and the data corresponding to the activities. The alert is generated when the KPI values are not met. Alerts can be sent to the user on the dashboard, mail or SMS.

According to another embodiment of the present invention, a computer program product (CPP) to monitor at least one business process is provided. The computer program product comprises instruction means to generate a business process model representing a set of activities in the at least one business process. Further, the computer program product includes instruction means to collect a set of application data stored by the set of applications. The CPP also includes instruction means that correlate a set of events to one of the activities in a process instance. Further, the CPP includes instruction means that capture the KPI values for the set of activities included in the generated business model. The CPP also includes instruction means that generate an alert for the completed activities based on the captured KPI and SLA values and the data corresponding to the activities. The alert is generated when the KPI values are not met. Alerts can be sent to the user on the dashboard, mail or SMS.

These and other objects and advantages of the present invention will become readily apparent from the following detailed description taken in conjunction with the accompanying drawings.

### BRIEF DESCRIPTION OF THE DRAWINGS

The other objects, features and advantages will occur to those skilled in the art from the following description of the preferred embodiment and the accompanying drawings in which:

FIG. 1 illustrates a flow chart representing a method to monitor business transactions in at least one business process non-intrusively, according to one embodiment of the present invention;

FIG. 2 illustrates a functional block diagram of a non-intrusive system to monitor business transactions in at least one business process, according to one embodiment of the present invention;

FIG. 3 illustrates a detailed block diagram of a non-intrusive system to monitor business transactions in at least one business process, according to one embodiment of the present invention; and

FIGS. 4 and 5 illustrate block diagrams of model constructs used to determine a subsequent activity in the business process, according to various embodiments of the present invention.

Although specific features of the present invention are shown in some drawings and not in others. This is done for convenience only as each feature may be combined with any or all of the other features in accordance with the present invention.

### DETAILED DESCRIPTION

In the following detailed description, reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments of the present invention provide a system and method to monitor business transactions in at least one business process non-intrusively and to provide alerts to users to enable the users to take alternate preventive/corrective action for a specific business process instance, when business events like SLA violation occurs.

Examples of a business process include, but are not limited to, an inventory management process, payroll process, and a retail banking process. Each of these business processes has a number of business transactions. Business transaction in a process like inventory management process include, among others, purchase, sales, shipping, shrinkage etc. While performing each of these transactions, the business process carries out a set of activities using a plurality of applications. The set of activities can include adding a row to a database table about a new purchase being made among other activities. When a business process is monitored, using the method described in the following paragraphs, the transaction need not be stopped and an alert is generated in near real-time.

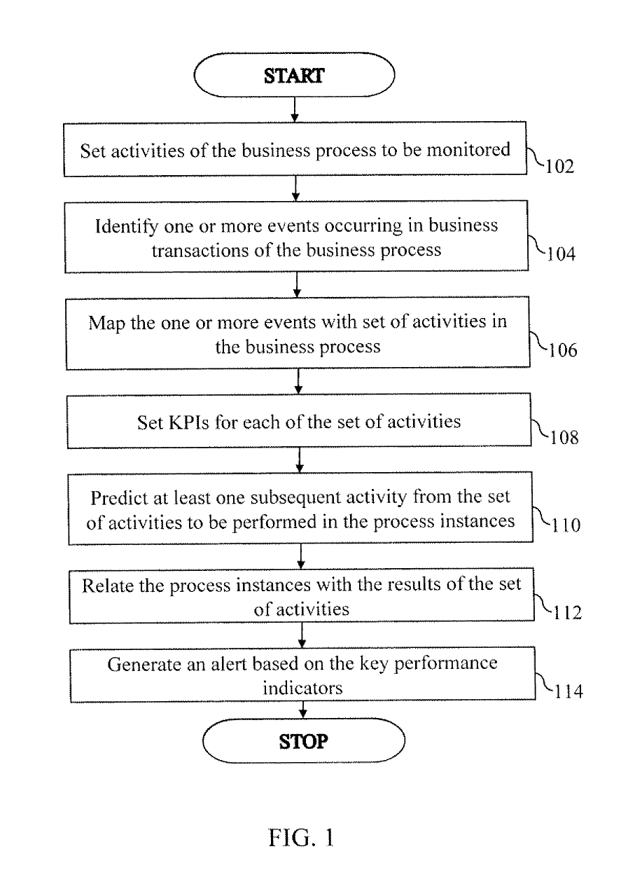

FIG. 1 illustrates a method for monitoring business transactions in at least one business process non-intrusively, according to one embodiment of the present invention. At step 102, a set of activities occurring in at least one business process to be monitored are set up by generating a business model corresponding to the business process to be monitored. According to one embodiment of the present invention, the business processes which are to be monitored can be modeled using standard modeling tools using BPEL standard. A person skilled in the art may be aware that there exist multiple technologies and solutions to model a business process. The process model includes the activities and the flow of the processes.

At step 104, one or more events occurring in the business transactions are identified using a set of application data generated by the set of applications used in the business process. The set of application data can be present in data log files, databases, or system log files. The events are identified by determining any change in the state of the set of application data. Examples of changes in the set of application data include, but are not limited to, addition of a new row in a database table, update a change of column in a database table, entries made to a log file etc.

Further, at step 106 of the method, the one or more events are mapped to the set of activities in the business process based on a set of predefined mapping rules. The event can mark either a start of a process, or end of the process, or start of an activity or end of the activity. According to one embodiment, activities include a query that reads the application data and the set of predefined mapping rules to map the set of activities with the events. The set of predefined mapping rules take into consideration operation of the event, sender, or receiver of the event to map each of the identified events to the set of activities. Each activity is assigned a correlation code as at least one name-value pair. The correlation code ties an activity with the process instance that initiated it. At step 108, key performance indicators (KPIs) are defined for each of the set of activities. KPIs defined at step 108 are used to check the status of data generated by each of the one or more events.

Further, at step 110, at least one subsequent activity from the set of activities to be performed in the process instance is determined. The subsequent activity is determined using the process model set up at step 102. Further, according to one embodiment of the present invention, as an activity is in progress the process instance expecting that activity is identified. The activity is mapped to the right process instance using the correlation code assigned to each activity. The next subsequent activity for the process instance is inferred from the process model and the process instance waits for the subsequent activity to be completed. At step 112 of the method, an alert is generated for the process instance when the results of the activities do not meet the KPIs set at step 108. The alert can be communicated to the process administrator through means like e-mail, call, SMS, paging message, or a notification on a dashboard etc.

According to one embodiment of the present invention, when the one or more events are identified for a particular process instance they are mapped to the set of activities using the set of application data. Further, if it is determined that an event is a process start type of event a new process instance is created and the set of activity generating the event is assigned a new correlation code. Subsequent activities are determined from the process model and the process instance now waits for the subsequent activities to be completed. Each of the one or more identified events are thus scanned and mapped to the right process instance.

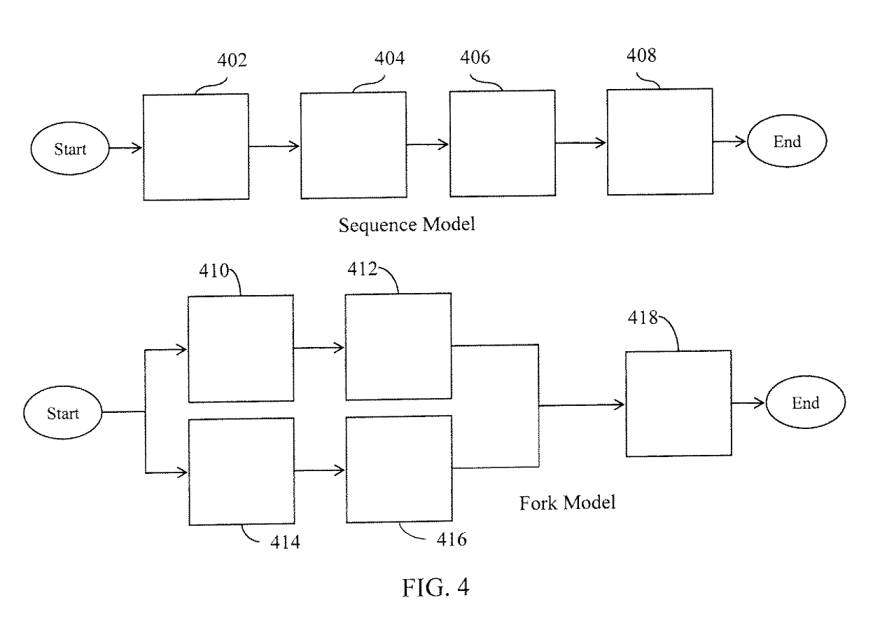

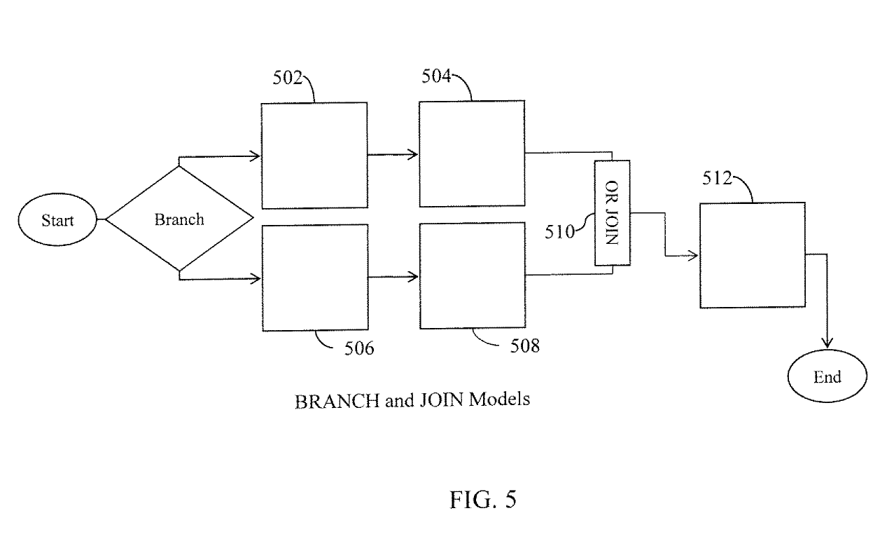

According to another embodiment of the present invention, subsequent activities for a process instance are determined by a path in the process model that data can take for completion of the process. Various ways/model constructs of determining subsequent activities are detailed in FIGS. 4 and 5. A person skilled in the art will be able to determine the applicability of the method and system in other existing model constructs. A sequence model construct indicates that there is only one subsequent activity for the current activity in the process flow. Ex. Activity 402 will always have activity 404 as the subsequent activity. In a fork (parallel-split or inclusive gateway) construct where more than one paths of data flow are possible there can be more than one activity from the set of activities that can be tagged as subsequent activities. These activities are maintained as subsequent activities till all the activities are completed.

In a branch model construct as shown in FIG. 5, the subsequent activity is one after a branching condition. Each activity after a branch in the process model is identified as a subsequent activity. Based on the activity that occurs after the current activity, a branch is chosen and other activities are dropped from the subsequent activities list. Further, in a join construct the activity after the join 510 is the subsequent activity. For example in FIG. 5, activity 512 is a subsequent activity for activities 506 and 508. In a simple merge join, activity 512 can happen if any of the activities 506 or 508 are completed whereas in synchronization join, activity 512 can happen only if both 506 and 508 are completed.

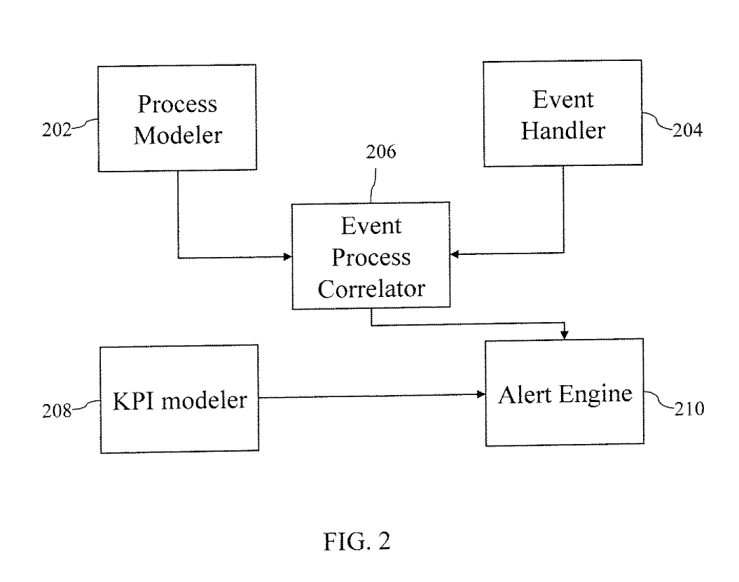

FIG. 2 illustrates a block diagram for a non-intrusive system to monitor business transactions in at least one business process, according to one embodiment of the present invention. The at least one business process involves data processing in a set of applications. An instance of the business process, referred to hereinafter as process instance, invokes at least one application from the set of applications to perform a set of activities. The system includes a process modeler 202, an event handler 204, an event-process correlator 206, a key performance indicator modeler 208, and an alert engine 210.

The process modeler 202 generates a business model of the at least one business process. While generating the business model the process modeler 202 models the set of activities in the business process. According to one embodiment of the present invention, the business processes which are to be monitored can be modeled using standard modeling tools using BPEL standard. A person skilled in the art may be aware that there exist multiple technologies and solutions to model a business process. The process model includes the activities and the flow of the processes.

Further, the event handler 204 collects a set of application data generated by the set of applications. The application data is stored in various forms and repositories. The data can be stored in databases, log files, message queues of applications, e-mails. The events are identified by determining any change in the state of the set of application data. Examples of changes in the set of application data include, but are not limited to, addition of a new row in a database table, update a change of column in a database table, entries made to a log file etc. The event handler 204 also assigns a correlation code to each event generated from the set of application data.

The event-process correlator 206 relates each of the one or more events with the process model based on a set of predefined mapping rules. An event can mark either start of a process, or end of the process, or start of an activity or end of the activity. According to one embodiment, the event-process correlator 206 includes a query that reads the application data and the set of predefined mapping rules to map the set of activities with the events. The set of predefined mapping rules take into consideration operation of the event, sender, or receiver of the event to map each of the identified events to the set of activities. When a process start event is received a new process instance is created or a process instance is progressed to the next step when an activity event is identified. The correlator code assigned by the event handler 204 is used to maintain a queue of process instances.

The event process correlator 206 also determines at least one subsequent activity from the set of activities to be performed in the process instance. The subsequent activity is determined using the process model set up by the process modeler 202. Further, according to one embodiment of the present invention, as an activity is in progress the process instance expecting that activity is identified. The activity is mapped to the right process instance using the correlation code assigned to each activity. The next subsequent activity for the process instance is inferred from the process model and the process instance waits for the subsequent activity to be completed. The ways of determining the subsequent activity are detailed out in FIGS. 4 and 5.

Further, the key performance indicator (KPI) modeler 208 is used to set KPIs for transactions in the at least one process that needs to be monitored. The KPIs set by the KPI modeler 208 are used by the alert engine 210 to generate alerts for business transactions in the business process that do not meet the desired results. The alerts engine 210 delivers the alerts to the process administrator in various ways. These ways include e-mail, SMS, paging message, instant messages, call, or an alert on a dashboard associated with the non-intrusive system.

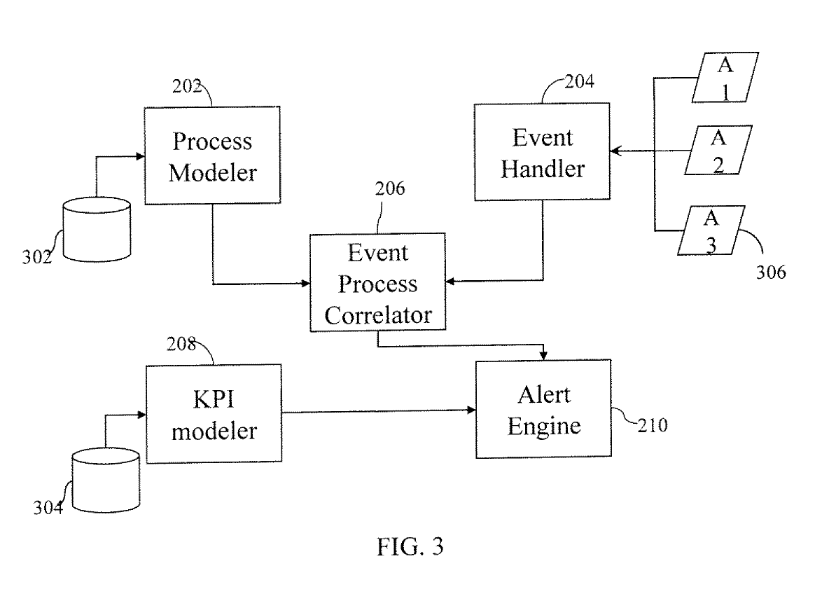

FIG. 3 illustrates a details block diagram of the non-intrusive system for monitoring business transactions in a business process that was explained using FIG. 2. The system illustrated in the detailed block diagram of FIG. 2 includes all elements from FIG. 2 along with repositories to store the set of application data, KPIs, correlation code, and an activity queue. These repositories are used by event handler 204, event-process correlator 206 and KPI modeler 208 to generate events, store subsequent activities for a current activity in progress for a business process instance, KPIs for each of the set of activities in the business process, and correlation codes for each of the set of activities in the business process.

As will be appreciated by those ordinary skilled in the art, the foregoing example, demonstrations and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

While the following description is presented to enable a person of ordinary skill in the art to make and use the invention and is provided in the context of the requirement for a obtaining a patent the present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

Many modifications of the present invention will be apparent to those skilled in the arts to which the present invention applies. Further, it may be desirable to use some of the features of the present invention without the corresponding use of other features.

Accordingly, the foregoing description of the present invention should be considered as merely illustrative of the principles of the present invention and not in limitation thereof.

1. A method for monitoring business transactions in at least one business process non intrusively, the at least one business process comprising data processing from at least one application wherein a process instance invokes at least one application to perform a set of activities, the method comprising:
setting activities of the at least one business process to be monitored;
identifying one or more events occurring in the business transactions of the at least one business processes using a set of application data from at least one application;
mapping the one or more events to the set of activities in the business processes based on a set of predefined mapping rules;
setting key performance indicators for each of the set of activities;
determining at least one subsequent activity from the set of activities to be performed in the process instance;
relating the process instance with results of activities performed from the set of activities; and
generating an alert for the process instance when any of the set of activities fail to meet the key performance indicators.

2. The method according to claim 1, wherein the step of setting activities comprises generating a business model for the at least one business process to be monitored.

3. The method according to claim 1, wherein the step of setting activities comprises generating a correlation code for each of the set of activities as at least one name-value pair.

4. The method according to claim 1, wherein the step of setting activities comprises defining a query to read the application data and the set of predefined mapping rules.

5. The method according to claim 1, wherein the events are identified based on changes in the set of application data.

6. The method according to claim 1, wherein the event is mapped to at least one of a process start event, or process end event or activity start event or activity end event.

7. The method according to claim 3, wherein each completed activity is compared with one determined activity and mapped to one process instance using the correlation code.

8. The method according to claim 1, further comprises displaying the alerts and results of business process monitoring reported in near real time.

9. A non intrusive system for monitoring at least one business process, the at least one business process comprising data processing in a set of applications, wherein a process instance invokes at least one application to perform a set of activities, the system comprising:
a process modeller to generate a business model of the at least one business process, wherein the process modeller models a set of activities in the at least one business process;
an event handler to collect a set of application data stored by the set of applications;
an event-process correlator to correlate a set of events to the set of activities belonging to process instances that need to be performed in the business process;
a key performance indicator (KPI) modeller to capture the KPI values for the set of activities in the business model; and
an alert engine to generate an alert for activities from the set of activities for which KPI values are not met.

10. The system according to claim 9, wherein the business model comprises a sequence of the set of activities and at least one correlation code for each activity.

11. The system according to claim 9, wherein the event-process correlator comprises a query to read the application data and a set of pre-defined rules to map the set of events to the set of activities.

12. The system according to claim 9, wherein the event handlers are run time component that run periodically to parse the application data of the applications.

13. The system according to claim 9, wherein the event handlers identify different kinds of events based on the changes in the application data.

14. The system according to claim 12, wherein the change in the collected and stored application data is at least one of update in application data in database table or creation of an entry in a log file or creating a new file.

15. The system according to claim 9, wherein the event handlers assign a unique correlation code for each generated event.

16. The system according to claim 9, wherein the event handler maps each event to an activity based on the mapping rules.

17. The system according to claim 8, wherein the event is mapped to at least one of a process start event, or process end event or activity start event or activity end event.

18. The system according to claim 9, wherein the event process correlator maintains a queue of completed activities and the subsequent activities to be executed based on the generated process model.

19. The system according to claim 15, wherein the event process correlator correlates each event to an activity in the business process based on the assigned correlation code.

20. The system according to claim 9, wherein the KPI modeller captures the KPI values for the processes and activities within the processes.

21. The system according to claim 9, wherein the alert engine compares the indicators of the completed activities with the defined key indicators to generate an alert based on the stored KPI values.

22. The system according to claim 21, further comprises a dashboard connected to the alert engine and the transaction database to output the generated alerts.

23. A computer program product for monitoring at least one business process, the at least one business process comprising data processing in a set of applications, wherein a process instance invokes at least one application to perform a set of activities, the computer program product comprising:
instruction means to generate a business model of the at least one business process, wherein the process modeller models a set of activities in the at least one business process;
instruction means to collect a set of application data stored by the set of applications;
instruction means to correlate a set of events to the set of activities belonging to process instances that need to be performed in the business process;
instruction means to capture the KPI values for the set of activities in the business model; and
instruction means to generate an alert for activities from the set of activities for which KPI values are not met.

24. The computer program product according to claim 23, wherein the instructions for setting up of activities include the instructions for generating business model for at least one business process to be monitored.

25. The computer program product according to claim 23, wherein the instructions for setting of activities include the instructions for capturing correlation code for each activity at least one name-value pair to compare each completed activity with one determined activity.

26. The computer program product according to claim 23, wherein the instructions for setting up of activities include the instructions for capturing key performance indicators.

27. The computer program product according to claim 23, wherein the instructions for creating alerts include instructions for generating alerts, when the preset rules or key performance indicators are not met.
